(19) United States
(12) Patent Application Publication
(10) Pub. No.: US 2026/0187837 A1
(43) Pub. Date: Jul. 2, 2026

(54) CONTROL SYSTEM AND METHOD FOR SENSING COLLABORATION

(71) Applicant: COMPAL ELECTRONICS, INC., Taipei City (TW)

(72) Inventors: Meng-Huan Tsai, Taipei City (TW); Hua Liu, Taipei City (TW); Chen-Cheng Wang, Taipei City (TW); Kung-Ju Chen, Taipei City (TW)

(73) Assignee: COMPAL ELECTRONICS, INC., Taipei City (TW)

(21) Appl. No.: 19/419,084

(22) Filed: Dec. 14, 2025

Related U.S. Application Data
(60) Provisional application No. 63/738,836, filed on Dec. 26, 2024.

(51) Int. Cl. G06T 7/73; G01K 3/00; G01S 17/894; G06T 7/50; G06V 10/12; G06V 10/25; G06V 10/44; G06V 40/20

(52) U.S. Cl. CPC G06T 7/74; G01K 3/005; G01S 17/894; G06T 7/50; G06V 10/12; G06V 10/25; G06V 10/44; G06V 40/20; G06T 2207/30196

(57) ABSTRACT

Provided are a control system and a method for sensing collaboration. In the method, a target region is detected from a first image through a processor. The first image is obtained by a color camera. The target region corresponds to a first coordinate information. Next, the first coordinate information is converted to a second coordinate information through the processor. The second coordinate information corresponds to an imaging plane of a time of flight camera. A depth value corresponding to the second coordinate information is obtained from a depth information through the processor. The time of flight camera obtains the depth information. A sensing data of the target region is determined according to the depth value through the processor. In this way, the disclosure combines the advantages of different sensors and enhances the precision of target positioning in a three-dimensional space.

### CROSS-REFERENCE TO RELATED APPLICATION

This application claims the priority benefit of U.S. provisional application Ser. No. 63/738,836, filed on Dec. 26, 2024. The entirety of the above-mentioned patent application is hereby incorporated by reference herein and made a part of this specification.

### BACKGROUND

### Technical Field

The disclosure relates to an image processing technology, and particularly relates to a control system and a method for sensing collaboration.

### Related Art

Spatial ranging technology has been widely applied in fields such as navigation, artificial intelligence robots, and IoT smart living. However, in practical applications, existing spatial ranging technology faces problems, such as information transmission delay, data inconsistency, and user operation complexity.

For example, an advantage of technologies, such as time of flight (ToF) or stereo vision, is the ability to provide a depth information of an object in an image. However, a disadvantage for this type of technologies is that the image resolution is usually lower, and there are also requirements for ambient light. In addition, some technologies, such as structured light, are not adapted for a long-distance application scenario.

### SUMMARY

The disclosure provides a control system and a method for sensing collaboration, which can compensate the problem of insufficient positioning precision in current spatial ranging technology.

The control system for sensing collaboration according an embodiment of the disclosure includes a color camera, a time of flight camera, and a processor. The color camera is configured to obtain a first image. The time of flight camera is configured to obtain a second image and a depth information corresponding to multiple pixels in the second image. The processor is communicatively connected to the color camera and the time of flight camera, and configured to: detect a target region from the first image; the target region corresponds to a first coordinate information; the first coordinate information includes a first coordinate value on two axes corresponding to an imaging plane of the color camera; convert the first coordinate information to a second coordinate information; the second coordinate information includes a second coordinate value on two axes corresponding to an imaging plane of the time of flight camera; obtain a depth value corresponding to the second coordinate information from the depth information; and determine a sensing data of the target region according to the depth value.

The method for sensing collaboration according to an embodiment of the disclosure includes (but is not limited to) the following steps: a target region is detected from a first image through a processor; a color camera obtains the first image; the target region corresponds to a first coordinate information; the first coordinate information includes a first coordinate value on two axes corresponding to an imaging plane of the color camera; the first coordinate information is converted to a second coordinate information through the processor; the second coordinate information includes a second coordinate value on two axes corresponding to an imaging plane of a time of flight camera; a depth value corresponding to the second coordinate information is obtained from a depth information through the processor; the time of flight camera obtains the depth information; and a sensing data of the target region is determined according to the depth value through the processor.

Based on the above, the control system and the method for sensing collaboration according to the embodiments of the disclosure use the higher resolution characteristics of the color camera to perform precise two-dimensional target positioning, and then query the time of flight camera for the depth value corresponding to a two-dimensional position through a coordinate conversion mechanism. This method combines the advantages of the two types of sensors, compensates the disadvantages of existing spatial ranging technology, and further enhances the overall precision of target positioning in a three-dimensional space.

In order to make the features and advantages of the disclosure more comprehensible, the following examples are given and described in detail with the accompanying drawings as follows.

### BRIEF DESCRIPTION OF THE DRAWINGS

FIG. 1 is a block diagram of a control system for sensing collaboration according to an embodiment of the disclosure.

FIG. 2 is a flowchart of a method for sensing collaboration according to an embodiment of the disclosure.

FIG. 3 is a flowchart of detecting a target region according to an embodiment of the disclosure.

FIG. 4A is a schematic diagram of a first image according to an embodiment of the disclosure.

FIG. 4B is a schematic diagram of coordinate mapping between a first image and a second image according to an embodiment of the disclosure.

FIG. 5 is a flowchart of converting a first coordinate information to a second coordinate information according to an embodiment of the disclosure.

FIG. 6 is a schematic diagram of a coordinate system mapping relationship between a color camera and a time of flight camera according to an embodiment of the disclosure.

FIG. 7 is a flowchart of determining an operation behavior according to an embodiment of the disclosure.

FIG. 8 is a flowchart of determining an operation according to an embodiment of the disclosure.

FIG. 9A is a schematic diagram of a touch operation according to an embodiment of the disclosure.

FIG. 9B is a schematic diagram of a lift operation according to an embodiment of the disclosure.

FIG. 10 is a flowchart of screening a target according to an embodiment of the disclosure.

FIG. 11 is a schematic diagram of a temperature measurement scenario according to an embodiment of the disclosure.

FIG. 12 is a flowchart of obtaining a representative temperature value according to an embodiment of the disclosure.

FIG. 13 is a schematic diagram of performing a temperature measurement in a target region according to an embodiment of the disclosure.

FIG. 14 is a flowchart of determining a normal or abnormal temperature according to an embodiment of the disclosure.

### DESCRIPTION OF THE EMBODIMENTS

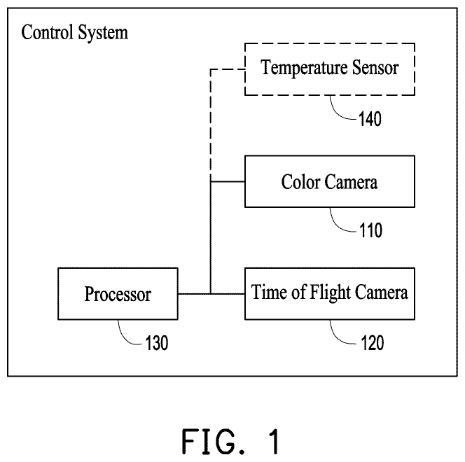

FIG. 1 is a block diagram of a control system 100 for sensing collaboration according to an embodiment of the disclosure. Referring to FIG. 1, the control system 100 may be any one or more electronic devices or computing systems with computing capabilities. For example, a projector, a smart display, a security system, a medical equipment, or a computing system installed in the foregoing devices. The control system 100 includes (but is not limited to) a color camera 110, a time of flight camera 120, and a processor 130.

The color camera 110 is, for example, a red, green, blue (RGB) camera. The color camera 110 includes an image sensor. The image sensor may sense, for example, color information (such as light intensity values) of red, blue, and green light. In an embodiment, the color camera 110 is configured to capture a first image. This first image might include color and texture features, and is adapted for more accurate object feature recognition in some application scenarios.

The time of flight camera 120 is, for example, an indirect time of flight (iToF) or direct time of flight (dToF) camera. In an embodiment, the time of flight camera 120 is configured to obtain a depth information. The time of flight camera 120 calculates the time difference or time corresponding to a distance or a depth value by measuring the phase offset between an emitted signal and a reflected signal or the flight time of an optical signal. For example, one or more pixels in a second image captured by the time of flight camera 120 correspond to a depth value, and may be configured to form a depth map. In some application scenarios, an image resolution of the time of flight camera 120 is lower than an image resolution of the color camera 110.

The processor 130 is communicatively connected to the color camera 110 and the time of flight camera 120. The processor 130 is, for example, a central processing unit (CPU), a graphics processing unit (GPU), or other programmable general-purpose or special-purpose microprocessor, digital signal processor (DSP), programmable controller, field programmable gate array (FPGA), application-specific integrated circuit (ASIC), neural network accelerator, or other similar elements or a combination of the foregoing elements. In an embodiment, the processor 130 is configured to load and execute program codes, software modules, files, and data stored in the memory. In some embodiments, the function of the processor 130 may be implemented by a software or a chip. The function of the processor 130 is to execute the method for sensing collaboration described later to integrate and use the information from the color camera 110 and the time of flight camera 120.

In an embodiment, the control system 100 may further include a temperature sensor 140. The temperature sensor 140 is communicatively connected to the processor 130. The temperature sensor 140 is, for example, an infrared thermal imager, a thermopile sensor, or an infrared pyrometer. In an embodiment, the temperature sensor 140 is configured to sense an infrared radiation energy of a target, and generate a temperature information accordingly (such as a temperature value in Celsius or Fahrenheit).

In the following, the method described in the embodiments of the disclosure will be described in conjunction with the various elements and modules in FIG. 1. Various processes of the method may be adjusted according to an implementation condition, and are not limited thereto.

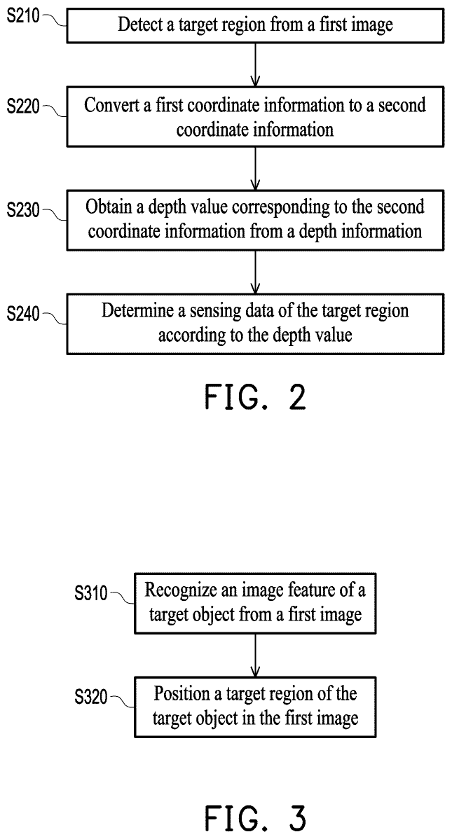

FIG. 2 is a flowchart of a method for sensing collaboration according to an embodiment of the disclosure. Referring to FIG. 2, in step S210, the processor 130 detects a target region from a first image. Specifically, the processor 130 obtains the first image through the color camera 110, and detects the target region in the first image. The target region refers to a specific range of interest in the image. The position thereof may be described by a first coordinate information, that is, a coordinate value of the target region on an imaging plane of the color camera 110.

FIG. 3 is a flowchart of detecting a target region according to an embodiment of the disclosure. Referring to FIG. 3, in step S310, the processor 130 may recognize an image feature of a target object from a first image. Specifically, the image feature refers to a key visual information that may represent the target object. The processor 130 may perform inference through a pre-trained deep learning model to recognize the image feature. For example, the target object is a hand. The processor 130 may input the first image to a hand landmark detection model. The model detects a hand region and generates a bounding box of the hand region. As another example, the target object is a human face. The processor 130 uses a face detection AI model to analyze the first image to obtain position information of all human faces in a test scenario.

In some embodiments, the processor 130 might perform feature matching of histogram of oriented gradient (HOG), scale-invariant feature transform (SIFT), Haar, and/or speeded up robust features (SURF) on the first image to recognize the target object.

In step S320, the processor 130 positions the target region of the target object in the first image. Specifically, the recognized image feature may correspond to a specific coordinate point or region. For example, for hand landmark detection, the processor 130 further inputs the (hand) image within the bounding box to the model to obtain a coordinate position (x_{rgb}, y_{rgb}) of the fingertip of the index finger (that is, a first coordinate value of a first coordinate information on two axes of an X-Y imaging plane of the color camera 110) to serve as the target region. As another example, for human face detection, the processor 130 calculates a center coordinate (x_{rgb_center}, y_{rgb_center}) of the human face bounding box (that is, a first coordinate value of a first coordinate information on two axes of an X-Y imaging plane of the color camera 110), and serves as the target region accordingly.

Referring to FIG. 2, in step S220, the processor 130 converts a first coordinate information to a second coordinate information. Specifically, in order to achieve information fusion of two different sensors, it is necessary to understand the relationship between the imaging coordinate systems of the two sensors. Since the resolutions, viewing angles, and physical positions of the color camera 110 and the time of flight camera 120 are usually different, their respective imaging planes and coordinate systems are also independent. To integrate the advantages of the two, a precise mapping relationship needs to be established.

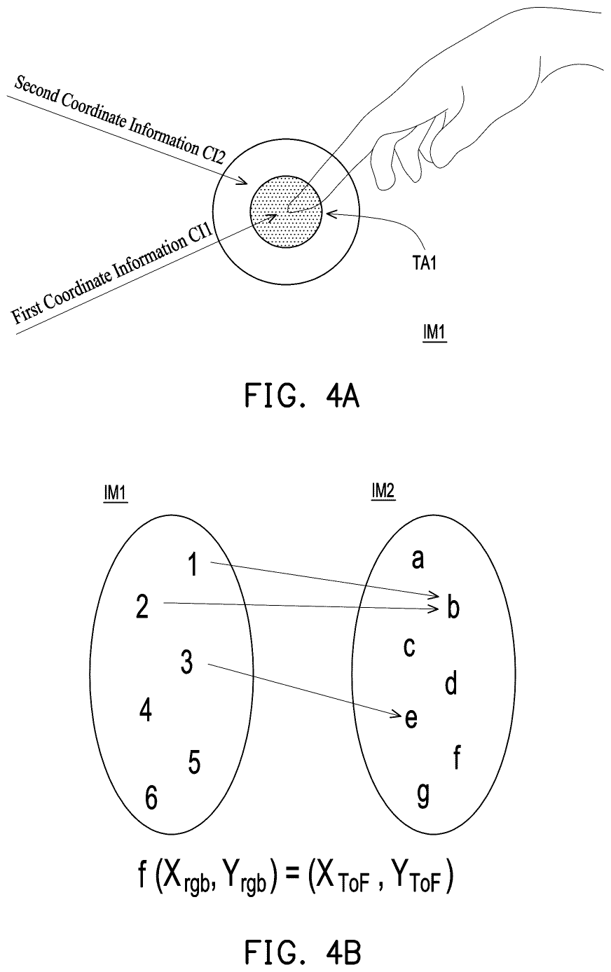

FIG. 4A is a schematic diagram of a first image IM1 according to an embodiment of the disclosure. FIG. 4B is a schematic diagram of coordinate mapping of the first image IM1 and a second image IM2 according to an embodiment of the disclosure. Please refer to FIG. 4A and FIG. 4B. As shown in FIG. 4A, the processor 130 positions a target region TA1 (such as a fingertip) in the first image IM1 obtained by the color camera 110, and obtains a corresponding first coordinate information CI1. As shown in FIG. 4B, the processor 130 maps the first coordinate information CI1 to the second image IM2 obtained by the time of flight camera 120, thereby obtaining a corresponding second coordinate information CI2. For example, the “1” position of the first image IM1 is mapped to the “b” position of the second image IM2. By substituting into the equation f(x_{rgb}, y_{rgb}), the coordinate (x_{rgb}, y_{rgb}) may be mapped to a coordinate (x_{ToF}, y_{ToF}) of an imaging plane of the time of flight camera 120.

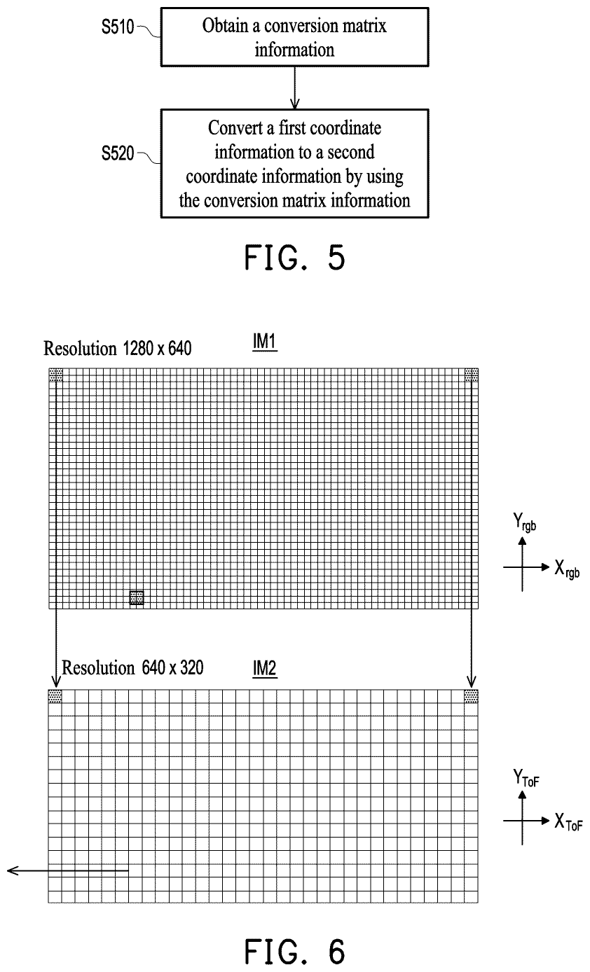

FIG. 5 is a flowchart of converting a first coordinate information to a second coordinate information according to an embodiment of the disclosure. Referring to FIG. 5, in step S510, the processor 130 may obtain a conversion matrix information for mapping multiple reference points on an imaging plane of the color camera 110 to a corresponding reference point on an imaging plane of the time of flight camera 120. Specifically, the conversion matrix information is a mathematical representation configured to describe how a point or a position in one coordinate system is mapped to another coordinate system. The function of the conversion matrix information is to establish a corresponding relationship between the imaging plane of the color camera 110 and the imaging plane of the time of flight camera 120.

FIG. 6 is a schematic diagram of a coordinate system mapping relationship between a color camera and a time of flight camera according to an embodiment of the disclosure. Referring to FIG. 6, the coordinate system of the color camera 110 with a 1280×640 resolution maps to the coordinate system of the time of flight camera 120 with a 640×320 resolution. Since the color camera 110 has a higher resolution, and the time of flight camera 120 has a lower resolution, multiple pixels in the first image IM1 of the color camera 110 correspond/map to a same pixel in the second image IM2 of the time of flight camera 120. As shown in the figure, four pixels in the first image IM1 correspond to one pixel in the second image IM2.

In an embodiment, the conversion matrix information includes a homography matrix. The processor 130 may calculate and obtain the matrix through a preparatory camera calibration procedure. For example, coordinates of the four points are respectively obtained in the two coordinate systems, the coordinates are used to establish two equations, and then a construction matrix is broken down into a homography matrix. A homography matrix His a 3×3 matrix. The mathematical expression thereof is as follows:

$$H = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] \qquad ( 1 )$$

The homography matrix H is configured to map a point (x_{rgb}, y_{rgb}) on the imaging plane of the color camera 110 to a point (x_{ToF}, y_{ToF}) on the imaging plane of the time of flight camera 120:

$$[ \begin{matrix}{x}_{ToF} \\ {y}_{ToF} \\ 1\end{matrix} ] = H \cdot [ \begin{matrix}{x}_{rgb} \\ {y}_{rgb} \\ 1\end{matrix} ] . \qquad ( 2 )$$

Referring to FIG. 5, in step S520, the processor 130 converts a first coordinate information to a second coordinate information by using the conversion matrix information obtained previously. Specifically, the processor 130 may substitute the first coordinate information of the target region (for example, the first coordinate value (x_{rgb}, y_{rgb})) is substituted into the computation of a conversion matrix (such as the foregoing equation (2)), thereby calculating the corresponding second coordinate information in the coordinate system of the time of flight camera 120 (for example, the second coordinate value is (x_{ToF}, y_{ToF})). For example, a coordinate (682, 436) in the first image of the color camera 110 with the 1280×640 resolution may be converted to a coordinate (341, 218).

Referring to FIG. 2, in step S230, the processor 130 obtains a depth value corresponding to the second coordinate information from a depth information. Specifically, the time of flight camera 120 may output a depth map in real-time. The value of each pixel represents a distance or a depth between an object in a corresponding direction and the time of flight camera 120. The depth map corresponds to the coordinate system of the imaging plane of the time of flight camera 120. The processor 130 calculates a position of the target region detected in the first image in the coordinate system of the time of flight camera 120 (that is, the second coordinate value of the second coordinate information), thereby finding the position in the depth map, and reading the depth value stored by the position in the depth map.

In step S240, the processor 130 determines a sensing data of the target region according to the depth value. Specifically, the specific content of the sensing data may vary according to different application scenarios. The sensing data may be information describing the state of an object, or may be a command for triggering a specific function. The following will describe specific applications of the sensing data with two embodiments.

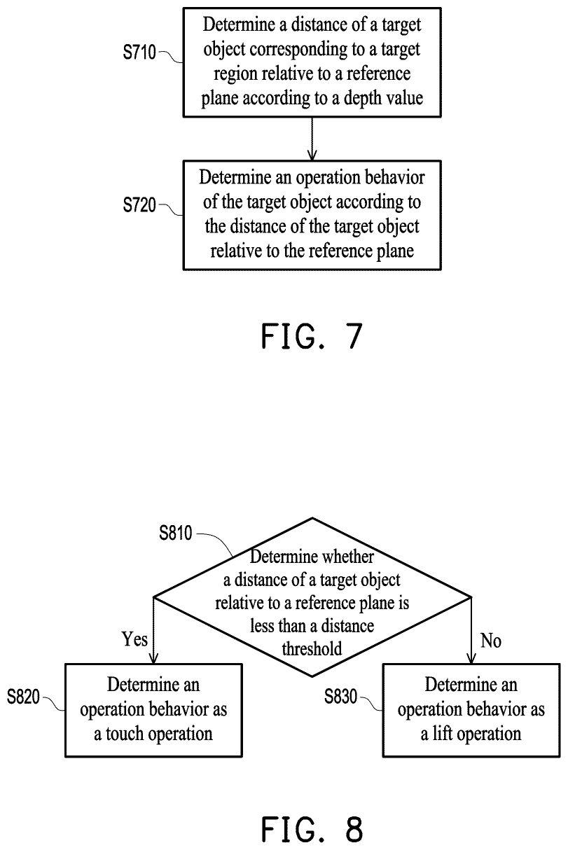

In a first embodiment, the sensing data corresponds to a touch operation. FIG. 7 is a flowchart of determining an operation behavior according to an embodiment of the disclosure. Referring to FIG. 7, in step S710, the processor 130 may determine a distance of a target object corresponding to a target region relative to a reference plane according to a depth value. Here, the reference plane is, for example, a wall or a tabletop of a projector display interface or other interactive interface. However, in other application scenarios, the reference plane might be a surface of other objects. The processor 130 may first use the time of flight camera 120 to measure the distance to the reference plane to serve as a reference distance. When the target object (such as a user's finger) is detected, as described in the foregoing steps S210 to S230, the depth value of the target object may be obtained. Therefore, the distance of the target object relative to the reference plane may be calculated from a difference between the reference distance and the depth value of the target object.

In step S720, the processor 130 may determine the operation behavior of the target object according to the distance of the target object relative to the reference plane. The type information of the operation behavior is the sensing data in the embodiment. According to different application scenarios, the type information is, for example, touch, lift, or left-right swing, and is not limited thereto.

For example, FIG. 8 is a flowchart of determining an operation according to an embodiment of the disclosure. Referring to FIG. 8, in step S810, the processor 130 may determine whether a distance of a target object relative to a reference plane is less than a distance threshold. Specifically, the distance threshold is a preset value, which is configured to serve as a critical standard for determining touch intent. The value of the distance threshold may be adjusted according to the sensitivity needs of the application scenario, and set as, for example, 0.5 centimeters, but is not limited thereto.

When the distance of the target object relative to the reference plane is less than the distance threshold (that is, yes in step S810), in step S820, the processor 130 determines the operation behavior as a touch operation. The touch operation may trigger a corresponding system event, such as inputting a character, clicking a button, or executing a specific function.

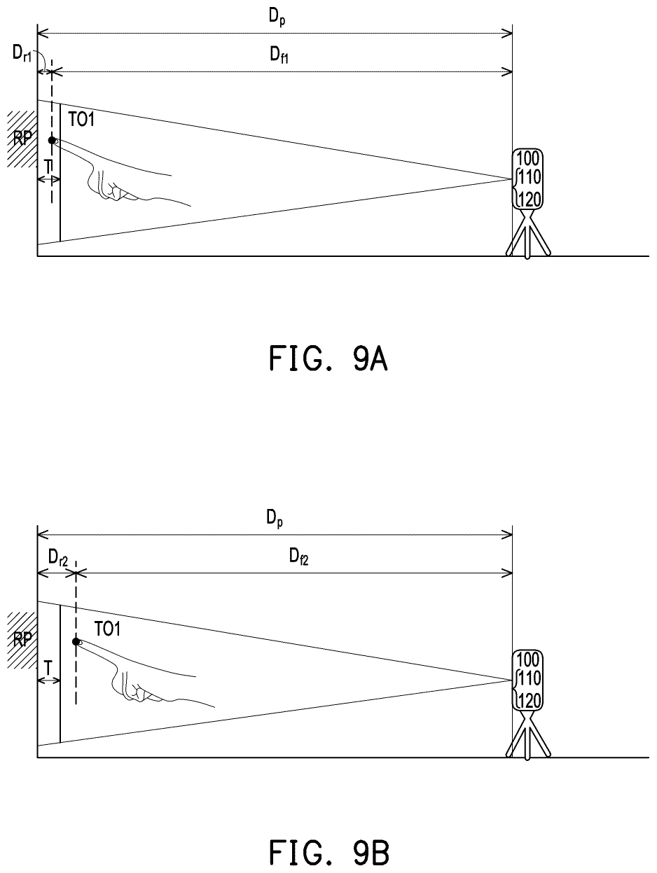

FIG. 9A is a schematic diagram of a touch operation according to an embodiment of the disclosure. Referring to FIG. 9A, in this scenario, a depth value D_{f1} (such as 69.8 centimeters) of a known target object TO1 and a distance D_{P} (such as 70 centimeters) from the time of flight camera 120 to a reference plane RP are known. The processor 130 may detect that a distance Dᵣ₁ (such as a difference between the distance D_{P} and the depth value D_{f1}) of the target object TO1 (such as a fingertip) relative to the reference plane RP is less than a preset distance threshold T (such as 0.5 centimeters). Therefore, the processor 130 determines this state as a touch operation.

Referring to FIG. 8, when the distance of the target object relative to the reference plane is not less than the distance threshold (that is, no in step S810), in step S830, the processor 130 determines the operation behavior as a lift operation. The lift operation represents that the target object is in a non-touch suspended state. For example, FIG. 9B is a schematic diagram of a lift operation according to an embodiment of the disclosure. Referring to FIG. 9B, in this scenario, a distance Dᵣ₂ (such as a difference between the distance D_{P} and a depth value D_{f2} (such as 69 centimeters)) of the target object TO1 relative to the reference plane RP is not less than (that is, greater than or equal to) the distance threshold T (such as 0.5 centimeters). Therefore, the processor 130 determines this state as a lift operation.

In a second embodiment, the sensing data corresponds to a body temperature measurement. The embodiment may be applied to scenarios such as public places or home care to perform quick and non-contact body temperature screening. In this application scenario, the temperature sensor 140 may be used.

FIG. 10 is a flowchart of screening a target according to an embodiment of the disclosure. Referring to FIG. 10, in step S1010, the processor 130 may determine whether a depth value corresponding to a target region is within a depth range. Specifically, the depth range is a preset effective measurement interval, and has a minimum value and a maximum value. The purpose of the depth range is to ensure the accuracy and relevance of temperature measurement and may save system computation resources. For example, according to the specifications of the temperature sensor 140 and application scenarios, the depth range may be set as 50 centimeters to 200 centimeters.

When the depth value of the target region is within the depth range (that is, yes in step S1010), in step S1020, the processor 130 may allow a determination of the sensing data of the target region. That is, the processor 130 may continue to perform subsequent temperature information processing for the target within the effective distance.

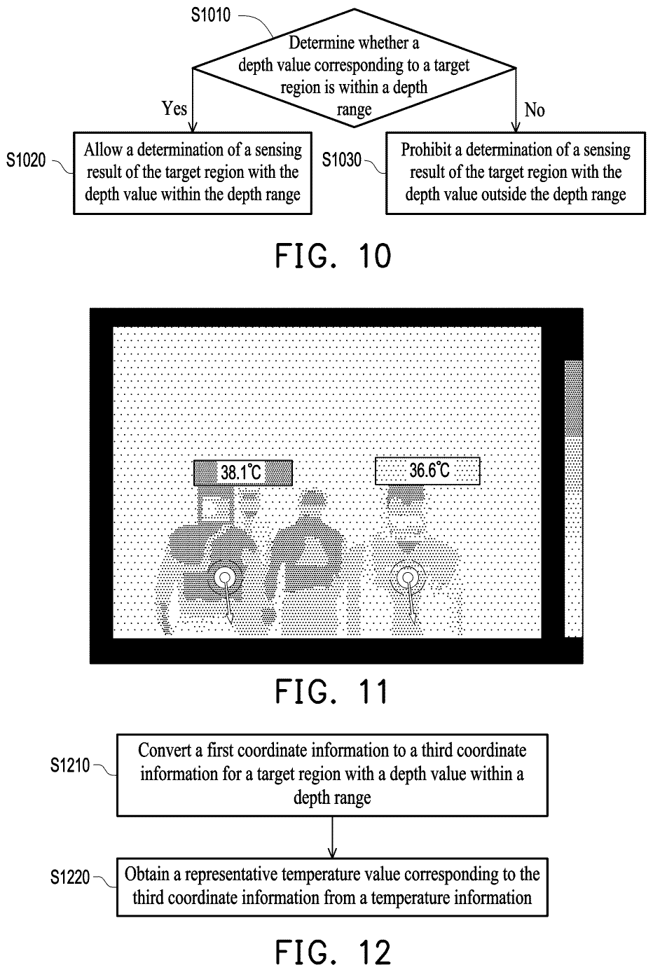

For example, FIG. 11 is a schematic diagram of a temperature measurement scenario according to an embodiment of the disclosure. Referring to FIG. 11, in this scenario, the control system 100 detects multiple target objects (such as multiple human faces). The processor 130 may determine a depth value of each target object one by one. For example, the two target objects labeled as 38.1° C. and 36.6° C. in the figure, since their depth values fall within a preset depth range, the processor 130 may continue to process their temperature information. If there are other targets that are too close or too far in the field of view, they may be filtered by this step.

Referring to FIG. 10, when the depth value of the target region is outside the depth range (that is, no in step S1010), in step S1030, the processor 130 may prohibit a determination of the sensing data of the target region. Specifically, the processor 130 may ignore a target object outside the depth range, prohibit/not perform subsequent temperature measurement and determination, and may directly return to process a next frame of image or a next target object. In this way, inaccurate measurement can be avoided, and overall system efficiency can be enhanced.

FIG. 12 is a flowchart of obtaining a representative temperature value according to an embodiment of the disclosure. Referring to FIG. 12, the process performs subsequent temperature information extraction for a target region that has passed the foregoing depth range screening.

In step S1210, the processor 130 may convert a first coordinate information to a third coordinate information for a target region with a depth value within a depth range. Specifically, the third coordinate information includes a third coordinate value on two axes corresponding to an imaging plane of the temperature sensor 140. That is, the third coordinate information refers to coordinates corresponding to the target region on the imaging plane of the temperature sensor 140. Since the temperature sensor 140 is also an independent sensing element, its coordinate system might be different from the coordinate system of the color camera 110 or the coordinate system of the time of flight camera 120. Therefore, another coordinate conversion is needed. The conversion may also be accomplished through a pre-calibrated conversion matrix information (such as another set of homography matrix).

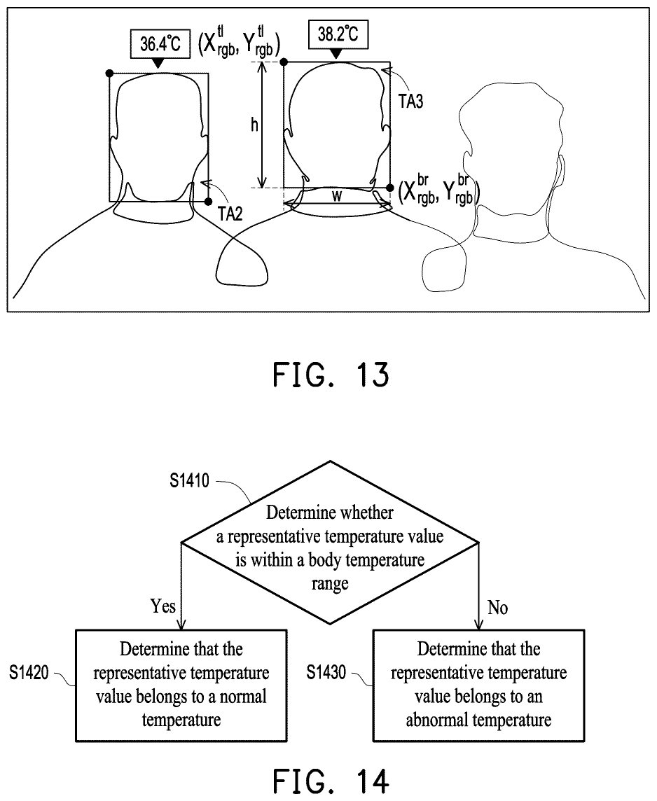

For example, FIG. 13 is a schematic diagram of performing a temperature measurement in a target region according to an embodiment of the disclosure. Referring to FIG. 13, the processor 130 may frame target regions TA2 and TA3 of target objects (such as two faces) in a first image of the color camera 110. Taking the target region TA3 as an example, the target region has a width w and a height h, and has, for example, a bounding box defined by coordinates

$$( {x}_{rgb}^{tl} , {y}_{rgb}^{tl} )$$

of a upper left corner and coordinates

$$( {x}_{rgb}^{br} , {y}_{rgb}^{br} )$$

of a lower right corner. The processor 130 converts the coordinates of the two corners to a third coordinate information in the coordinate system of the temperature sensor 140, for example, obtaining coordinates

$$( {x}_{ir}^{tl} , {y}_{ir}^{tl} )$$

of the upper left corner and coordinates

$$( {x}_{ir}^{br} , {y}_{ir}^{br} )$$

of the lower right corner.

Referring to FIG. 12, in step S1220, the processor 130 may obtain a representative temperature value corresponding to the third coordinate information from a temperature information. Specifically, the processor 130 may use the third coordinate information converted from the previous step to frame a corresponding rectangular range in a thermal image output by the temperature sensor 140. For example, using the coordinates

$$( {x}_{ir}^{tl} , {y}_{ir}^{tl} )$$

of the upper left corner and the coordinates

$$( {x}_{ir}^{br} , {y}_{ir}^{br} )$$

of the lower right corner to frame the corresponding region range in the thermal image obtained by the temperature sensor 140. Next, the processor 130 may calculate an average, a maximum value, or a smooth-processed value of all pixel temperature values within the region range to serve as the “representative temperature value” of the target region. As shown in FIG. 13, the processor 130 may respectively calculate the representative temperature values corresponding to the target regions TA2 and TA3 (such as 38.2° C. and 36.4° C.). At this time, the sensing data includes the representative temperature value.

FIG. 14 is a flowchart of determining a normal or abnormal temperature according to an embodiment of the disclosure. Referring to FIG. 14, after a representative temperature value is obtained, the processor 130 may perform a final temperature state determination.

In step S1410, the processor 130 may determine whether the representative temperature value is within a body temperature range. Specifically, the body temperature range is a preset normal human body temperature interval, and has a minimum normal body temperature lower limit and a maximum normal body temperature upper limit. The body temperature range may be adjusted based on medical recommendations or application scenarios. For example, the minimum normal body temperature lower limit may be set as 35.0 degrees Celsius, and the maximum normal body temperature upper limit may be set as 37.5 degrees Celsius.

When the representative temperature value is within the body temperature range (that is, yes in step S1410), in step S1420, the processor 130 may determine that the representative temperature value belongs to a normal temperature. Conversely, when the representative temperature value is outside the body temperature range (that is, no in step S1410), in step S1430, the processor 130 may determine that the representative temperature value belongs to an abnormal temperature (too high or too low). The processor 130 may output the determination result by, for example, displaying on a screen or triggering an alert.

In summary, according to the embodiments of the disclosure, the control system and the method for sensing collaboration integrate the color camera with the higher resolution and the time of flight camera providing the depth information, and successfully combine the advantages of the two through a coordinate conversion mechanism. The disclosure uses the color camera to perform precise two-dimensional target positioning, and then queries the time of flight camera for the depth value of the corresponding position, thereby implementing high-precision three-dimensional spatial positioning. This architecture not only overcomes the limitations of a single sensor in precision or depth perception, but also can be flexibly applied to various scenarios such as non-contact touch determination or body temperature measurement combined with depth screening, significantly enhancing the accuracy of interactive experience and the efficiency of system operation.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A control system for sensing collaboration, comprising:
a color camera, configured to obtain a first image;
a time of flight (ToF) camera, configured to obtain a second image and a depth information corresponding to a plurality of pixels in the second image; and
a processor, communicatively connected to the color camera and the time of flight camera, and configured to:
detect a target region from the first image, wherein the target region corresponds to a first coordinate information, and the first coordinate information comprises a first coordinate value on two axes corresponding to an imaging plane of the color camera;
convert the first coordinate information to a second coordinate information, wherein the second coordinate information comprises a second coordinate value on two axes corresponding to an imaging plane of the time of flight camera;
obtain a depth value corresponding to the second coordinate information from the depth information; and
determine a sensing data of the target region according to the depth value.

2. The control system for sensing collaboration according to claim 1, wherein the processor is further configured to:
obtain a conversion matrix information for mapping a plurality of reference points on the imaging plane of the color camera to a corresponding reference point on the imaging plane of the time of flight camera, wherein the conversion matrix information comprises a homography matrix; and
convert the first coordinate information to the second coordinate information by using the conversion matrix information.

3. The control system for sensing collaboration according to claim 1, wherein the processor is further configured to:
recognize an image feature of a target object from the first image; and
position the target region of the target object in the first image.

4. The control system for sensing collaboration according to claim 1, wherein the processor is further configured to:
determine a distance of a target object corresponding to the target region relative to a reference plane according to the depth value; and
determine an operation behavior of the target object according to the distance of the target object relative to the reference plane, wherein the sensing data comprises the operation behavior.

5. The control system for sensing collaboration according to claim 1, wherein the processor is further configured to:
determine an operation behavior as a touch operation when a distance of a target object relative to a reference plane is less than a distance threshold; and
determine the operation behavior as a lift operation when the distance of the target object relative to the reference plane is not less than the distance threshold.

6. The control system for sensing collaboration according to claim 1, wherein the processor is further configured to:
allow a determination of the sensing data of the target region with the depth value within a depth range, and prohibit a determination of the sensing data of the target region with the depth value outside the depth range.

7. The control system for sensing collaboration according to claim 6, further comprising:
a temperature sensor, communicatively connected to the processor, and configured to obtain a temperature information, wherein the processor is further configured to:
convert the first coordinate information to a third coordinate information for the target region with the depth value within the depth range, wherein the third coordinate information comprises a third coordinate value on two axes corresponding to an imaging plane of the temperature sensor; and
obtain a representative temperature value corresponding to the third coordinate information from the temperature information, wherein the sensing data comprises the representative temperature value.

8. The control system for sensing collaboration according to claim 7, wherein the processor is further configured to:
determine that the representative temperature value belongs to a normal temperature when the representative temperature value is within a body temperature range; and
determine that the representative temperature value belongs to an abnormal temperature when the representative temperature value is outside the body temperature range.

9. A method for sensing collaboration, comprising:
detecting a target region from a first image through a processor, wherein a color camera obtains the first image, the target region corresponds to a first coordinate information, and the first coordinate information comprises a first coordinate value on two axes corresponding to an imaging plane of the color camera;
converting the first coordinate information to a second coordinate information through the processor, wherein the second coordinate information comprises a second coordinate value on two axes corresponding to an imaging plane of a time of flight camera;
obtaining a depth value corresponding to the second coordinate information from a depth information through the processor, wherein the time of flight camera obtains the depth information; and
determining a sensing data of the target region according to the depth value through the processor.

10. The method for sensing collaboration according to claim 9, wherein converting the first coordinate information to the second coordinate information comprises:
obtaining a conversion matrix information for mapping a plurality of reference points on the imaging plane of the color camera to a corresponding reference point on the imaging plane of the time of flight camera, wherein the conversion matrix information comprises a homography matrix; and
converting the first coordinate information to the second coordinate information by using the conversion matrix information.

11. The method for sensing collaboration according to claim 9, wherein detecting the target region from the first image comprises:
recognizing an image feature of a target object from the first image; and
positioning the target region of the target object in the first image.

12. The method for sensing collaboration according to claim 9, wherein determining the sensing data of the target region according to the depth value comprises:
determining a distance of a target object corresponding to the target region relative to a reference plane according to the depth value; and
determining an operation behavior of the target object according to the distance of the target object relative to the reference plane, wherein the sensing data comprises the operation behavior.

13. The method for sensing collaboration according to claim 9, wherein determining an operation behavior of a target object according to a distance of the target object relative to a reference plane comprises:
determining the operation behavior as a touch operation when the distance of the target object relative to the reference plane is less than a distance threshold; and
determining the operation behavior as a lift operation when the distance of the target object relative to the reference plane is not less than the distance threshold.

14. The method for sensing collaboration according to claim 9, wherein determining the sensing data of the target region according to the depth value comprises:
allowing a determination of the sensing data of the target region with the depth value within a depth range, and prohibiting a determination of the sensing data of the target region with the depth value outside the depth range.

15. The method for sensing collaboration according to claim 14, further comprising:
converting the first coordinate information to a third coordinate information for the target region with the depth value within the depth range, wherein the third coordinate information comprises a third coordinate value on two axes corresponding to an imaging plane of a temperature sensor; and
obtaining a representative temperature value corresponding to the third coordinate information from a temperature information, wherein the temperature sensor obtains the temperature information, and the sensing data comprises the representative temperature value.

16. The method for sensing collaboration according to claim 15, further comprising:
determining that the representative temperature value belongs to a normal temperature when the representative temperature value is within a body temperature range; and
determining that the representative temperature value belongs to an abnormal temperature when the representative temperature value is outside the body temperature range.
